(19) United States
(12) Patent Application Publication
(10) Pub. No.: US 2004/0026225 A1
(43) Pub. Date: Feb. 12, 2004

(54) Distillation method and appliances for fresh water production

(76) Inventor: Jean-Paul Domen, Vauchretien (FR)

Correspondence Address: Eric D Cohen, Welsh & Katz, 22nd Floor, 120 South Riverside Plaza, Chicago, IL, 60606, US

(21) Appl. No.: 10/297,440

(22) PCT Filed: Jun. 13, 2001
(86) PCT No.: PCT/FR01/01832

(30) Foreign Application Priority Data
Jun. 13, 2000 (FR) 00 07 480

(51) Int. Cl. B01D 1/00; B01D 3/00; B01D 1/22; B01D 3/08; B01D 3/28

(52) U.S. Cl. 203/23; 203/27; 203/89; 203/49; 203/98; 203/DIG. 1; 203/DIG. 8; 203/DIG. 4; 202/236; 159/49; 159/23; 159/901; 159/903; 159/DIG. 21

(57) ABSTRACT

The invention concerns appliances, one of which uses solar energy as sole source of power. It comprises an accumulation solar water heater (222) and quasi-reversible liquid/vapour heat exchanging alveolar elements, provided with hydrophilic coatings. Elements of types E and C, respectively assigned to water evaporation (224a, b, c) and to vapour condensation (226a-b) are interposed, with narrow free spaces, in a heat-insulated treatment chamber (223), arranged above the boiler (222). Hot water coming from the heater (222) flows in closed circuit, by thermosiphon, from the top downwards of elements E and from the bottom upwards of elements C. A slightly cooling member (242) is interposed between the bottom collectors (240-244) of elements E and C. Hot water spills over slowly from the top of the hydrophilic coatings of elements E and the vapour produced is condensed opposite, on the walls of elements C. Sea water to be distilled is introduced through a pipe (254) upstream of the bottom collector (244) of elements C. Two valves (264-257) regulate the circulation of hot water and the supply of sea water. A high performance coefficient is obtained in good economic conditions. The invention is useful for continuous production of fresh water and/or brine; for distillation of all liquids with standard boilers; for economical production of concentrates; and for cogeneration of electricity and fresh water.

The invention relates to novel distillation processes and plants and to particular heat exchangers used in these plants. Such processes and plants can have a very high performance coefficient, that is to say they are able to produce a quantity of fresh water, per unit of thermal power consumed, that is very much greater than the quantity of seawater evaporated by this same energy (1.4 liter/kWh). Two particular (but nonlimiting) applications of the invention relate mainly to the production of fresh water, especially from seawater, but also to the production of concentrates, such as syrups or brines.

Many liquid distillation plants use hollow heat exchangers to condense the vapor produced by the heating of the liquid to be distilled. In the processes employed by these plants, vapor or air saturated with vapor can flow on the inside or the outside of the exchanger, while a cold liquid flows on the outside or the inside of the exchanger. The first case is that of the coil of stills for alcoholic liquids. The second case is that of various salt water distillation plants. In both cases, the performance coefficient is particularly low.

French patent 93/14615, granted to Desplats et al., discloses a seawater distillation plant in which:

a pump makes cold salt water flow in helical conduits, installed in a condensation chamber, then makes this water, thus heated up, spill as rain over similar conduits which are installed in an evaporation chamber and through which a suitable heating fluid flows;

a fan makes air flow, in a closed circuit, upward from the bottom of the evaporation chamber and downward from the top of the condensation chamber;

the air is heated and humidified in the evaporation chamber, and then passes into the condensation chamber where it cools and dries, while the vapor condenses on the conduits of this chamber; and

the fresh water is collected at the bottom of the condensation chamber and the brine at the bottom of the evaporation chamber.

In this plant, the heat delivered to the conduits of the evaporation chamber is not used very efficiently. This is because the heat of condensation of the vapor entrained by the circulating air serves only to heat up a little of the salt water to be distilled, before this water thus heated up undergoes more substantial heating in the evaporation chamber. Consequently, the performance coefficient of this distillation plant is low.

On the other hand, in plants exploiting the multiple-effect distillation technique, known as Multistage Flash (MSF) distillation, which has been used on a large industrial scale in many countries in the Persian Gulf for the desalination of seawater, another process is used which provides an excellent performance coefficient. This technique is briefly described on page 39 of the British journal New Scientist of Aug. 31, 1991, in an article entitled “Fresh water from the sea” which also gives quite a complete presentation of the principal seawater desalination techniques (distillation and reverse osmosis) then available and still being used. The MSF process, developed during the 50s, consists in heating seawater in a boiler in order to feed in succession evaporation and condensation chambers, with central partitions that are good heat conductors, said chambers (generally around twenty or so) being placed in series. From going from one chamber to another, the temperature decreases in stages by going from 95 to 45° C. for example. Thanks to the action of vacuum pumps, the presence of any noncondensable gas in these chambers is eliminated and the vapor pressure in said chambers decreases in stages, from a value close to atmospheric pressure in the case of the first chamber down to a low value in the case of the last one, in accordance with the quasi-exponential law well known to experts, which links the temperature of the water to its saturation vapor pressure. In each chamber, the water boils and evaporation occurs. Vapor condensation then takes place by natural convection on the central partition downstream of the chambers and on a number of vapor/liquid heat exchange elements consisting of narrow tubes, through which the seawater to be distilled flows countercurrently. The drops of condensed water are collected in each chamber, while the heat of condensation of the vapor is recovered so that the water present in the downstream chamber boils and the temperature of the seawater passing through the tubes and feeding the boiler is raised in stages. The performance coefficient of these distillation systems is high.

MSF units, installed by their tens in the Gulf region, are large factories each producing 4000 to 20,000 m³ of fresh water per day. The amounts of thermal energy and mechanical energy consumed by the boiler and the vacuum pumps are very considerable, but this poses no problem in these countries, something which is not the case in most others. The advantages of an MSF unit are its simplicity, its reliability, its lifetime and its low maintenance costs. On the other hand, the initial investment to put up an MSF unit is particularly high and its use is reserved for large conurbations (of the order of a million inhabitants). Because of its installation and operation costs, the MSF technique is not very suitable or completely unsuitable for the construction of units having a moderate daily production (a few hundred m³/day, for example) or a fortiori very small daily production (100 liters/day, for example) used for supplying small communities.

The present invention derives from a useful process for distilling seawater, used in solar stills for producing fresh water, these being described in an international patent application, published under the number WO 98/16474, filed by Jean-Paul Domen, the author of the present invention. This solar still consists of a cylindrical vessel several meters in length, made of flexible plastic and slightly inflated with air. It comprises three chambers which run into one another and thus form a closed circuit through which a stream of air generated by a fan flows. It includes an evaporation chamber placed above a first condensation chamber and a second condensation chamber placed on the end. The evaporation chamber has a black outer wall, provided with a transparent cover for thermal protection and slightly inflated with air, and an inner wall which constitutes a thin central partition separating it from the first condensation chamber. The internal surface of the walls of the evaporation chamber is provided with a hydrophilic coating, in which coating the seawater to be distilled, fed via a trough installed along the top generatrix of the vessel, slowly flows, by gravity and the capillary effect. The internal surfaces of the walls of the two condensation chambers are impermeable, while the first chamber has a thermally well insulated external surface and the second chamber has an external surface cooled by the action of a hydrophilic coating, kept constantly wet, exposed to the air and placed in the shade.

In the evaporation chamber of this solar still, the boiler produces both hot water and water vapor, from two evaporation surfaces, one directly heated by the heat source (the sun's rays) and the other consisting of the central partition. The fan circulates, in a closed circuit, a stream of air that carries away the vapor produced in the evaporation chamber to the first condensation chamber and then to the second condensation chamber. In the first condensation chamber, the stream of hot wet air that hugs the impermeable face of the central partition is, over the entire length of this partition, always slightly hotter (1) than the hot water which flows slowly, by gravity and capillary effect, in the hydrophilic coating of the other face of this partition and always slightly hotter (2) than the stream of air, cooled and dried in the second condensation chamber, which progressively heats up and humidifies, flowing in the opposite direction along this other face belonging to the evaporation chamber. It follows that, over the entire impermeable face of this central partition, water vapor condenses and that, across this central partition, some of the heat of condensation of this vapor is transmitted to the heated seawater which flows in the hydrophilic coating of the other face. In this way, the latent heat of condensation of the vapor, that has condensed on that face of the central partition which belongs to the first condensation chamber, is partially recycled into the evaporation chamber. As a result, further vapor is produced, this being carried away by the stream of air which circulates in a closed circuit in the three chambers. In both condensation chambers, air/water segregation occurs, which allows the fresh water to be collected at the bottom points of these two chambers. As regards the brine, this is collected at the bottom point of the central partition, on the evaporation chamber side.

This process gives promising results, but they are insufficient, however, for two main reasons. Firstly, the recycled part of the latent heat of condensation of the vapor is not very great because the heat exchanges between the first condensation chamber and the evaporation chamber are very slight. This is explained by the fact that (1) the stream of hot wet air, which participates in the heat exchange with the central partition, has a very small thickness compared with the transverse dimensions of the stream of air flowing in the first condensation chamber and (2) the total surface area of this central partition is necessarily limited by the maximum acceptable dimensions of the vessel. Under these conditions, the air leaving the first condensation chamber is still relatively hot and wet. The cooling and the drying of this air in the second condensation chamber are also not very effective, as they are subject to limitations similar to those of the first condensation chamber, namely a necessarily limited surface area of the cold outer wall and too great an average distance between this cold surface and the streams of air flowing inside.

The first object of the invention is to develop novel distillation processes which extrapolate the base concepts of J. P Domen's prior process.

The second object of the invention is to develop novel distillation processes which, in the presence of a noncondensable gas, carry out evaporation and condensation operations similar to those carried out in MSF systems.

The third object of the invention is to develop such processes so that they have particularly high performance coefficients and are capable of producing defined daily volumes of fresh water within a range going from 0.1 to a few hundred m³ per day.

The fourth object of the invention is to construct stills with a high performance coefficient, especially those designed to produce fresh water and/or concentrates of aqueous solutions, which are economic in terms of construction, operation and maintenance.

The fifth object of the invention is to construct stills, with a high performance coefficient, which are particularly well suited for treating, under economically advantageous conditions, the hot seawater produced by the cooling of marine engines installed on land or on board ships.

The sixth object of the invention is to construct solar stills, with a high performance coefficient, which are particularly well suited for producing fresh water, under economic conditions and using advantageous techniques, in dry coastal regions, in deserts with subsoil containing brackish water, or in tropical regions having only contaminated water.

The seventh object of the invention is to develop and manufacture various heat exchange elements that are effective but inexpensive, and particularly well suited to achieving considerable recycling of the latent heat of condensation of the vapor produced during distillation.

According to the invention, a novel general multiple-effect distillation process, intended to separate materials in solution from their liquid solvent, is characterized in that it uses a countercurrent heat exchange, one of the streams ensuring that the liquid evaporates and the other that vapor condenses, in such a way that, preferably in every operation region, the heat of condensation of the vapor is recovered in order to evaporate and/or reheat the liquid at a lower partial vapor pressure, this partial pressure being able to be varied and obtained by virtue of the presence of a noncondensable gas that ensures an approximately uniform total pressure. “Approximately uniform pressure” will in general be understood as not varying by more than 20 mbar, preferably not more than 10 mbar, and advantageously not more than 5 mbar.

According to a first particular feature of the above general process, the noncondensable gas is used as heat transfer fluid, however the evaporation and condensation operations are carried out on either side of the walls of a heat exchanger, through which walls the heat flux passes, the flows of the gas transporting the vapor are produced countercurrently during these operations, the liquid to be evaporated advances along one of the faces of these walls and the distilled liquid condenses on the other face, the hot and cold sources being located at the two ends of the stream of gas looped back on itself thus formed.

According to a combination of the above general process and its first particular feature, a first particular multiple-effect distillation process is characterized in that:

hollow and flat heat exchange elements having outer walls and, if necessary, inner walls suitable to ensure approximately uniform spreading of any liquid flowing over them by gravity and/or capillary effect are placed, so as to be vertical or inclined, in a thermally insulated treatment chamber, with narrow separating spaces, of approximately constant width, that are filled with a noncondensable gas;

the liquid to be distilled is heated and vapor is produced;

a stream of hot gas saturated with vapor flows downward inside the elements, while preferably hot liquid to be distilled flows uniformly along their outer walls;

at the outlet of these elements, a gas/liquid separation is carried out and the gas is slightly cooled before being introduced into the base of the spaces that separate the elements, so as to flow upward along their outer walls;

the gas leaving the top of these separating spaces bubbles into hot liquid and the circuit traveled through by this gas is thus a closed circuit;

the distillate is collected after gas/liquid separation; and

the concentrate is collected at the bottom of the spaces that separate the elements.

By virtue of these arrangements a first particular distillation process with a high performance coefficient is produced, this being a direct extrapolation of the concepts involved in the process described in J. P. Domen's international patent application commented upon above. In this novel process, the two evaporation surfaces of the prior process are separated and a certain distance apart, instead of belonging to the same evaporation chamber. This allows three important improvements to be made: (1) the possibility of having central heat exchange partitions of very large total surface area (the walls of all the installed elements being parallel), since the dimensions of the boiler no longer limit the surface area of these partitions; (2) the possibility of reducing, for the better, the thickness of the layers of saturated air flowing in the narrow open spaces along these heat exchange walls, and thus of increasing their coupling; and (3) the possibility of using a conventional boiler just as well as a solar one. Furthermore, this first process affords two new advantages: (1) excellent transmission of the heat of condensation of the vapor through the thin walls of the heat exchange elements, thanks to suitable, especially hydrophilic or wettable, internal and external coatings which allow flows as substantially uniform and relatively slow thin films of the liquid to be distilled and of the distilled liquid, on each side of these walls, and therefore good heat transfer from one to the other; (2) replacement of the second condensation chamber with any more appropriate heat exchange device, for example a coil immersed in liquid at the external temperature.

However, this novel process does have the drawback that the low-power-consumption fan used in the prior process has to be replaced with a turbine of appreciably greater power consumption. This is needed to compensate for the relatively large power losses of the stream of air, at the initial pressure and speed, which flows at a locally increased speed in the inevitably narrow connection members at the inlet and outlet of the various flat heat exchange elements used. Moreover, the need for there to be particular heat exchange elements having hydrophilic internal and external coatings should be noted. Under these conditions, the complexity and the manufacturing cost of these particular elements will be appreciably greater than those of the standard elements that will be defined below. Despite these various drawbacks, the benefit in using, in certain particular cases, this first distillation process according to the invention will become apparent later.

The second and third particular distillation processes according to the invention allow an appreciable reduction in, or even complete elimination of, a need for mechanical energy, while maintaining most of the advantages of the first particular process defined above.

According to a second particular feature of the general process defined above, the evaporation of the liquid to be distilled is carried out on one or more hot surfaces, operating at a nonuniform temperature, these being installed in a first treatment chamber, and the condensation of vapor carried out on one or more other surfaces, operating at a nonuniform temperature generally colder than the previous one(s), these other surfaces being installed in a second treatment chamber communicating with the first via the top and via the bottom, the various regions of the evaporation and condensation surfaces being locally maintained at the required temperatures by virtue of the countercurrent circulation of a heat transfer fluid along these surfaces, a hot source being placed between the hottest ends of the evaporation and condensation surfaces and a cold source, installed between their coldest ends, the heat exchanges between the hot surface(s) and the colder surface(s) being ensured by the closed-circuit circulation, in a direction opposite to that of the heat transfer fluid, of a noncondensable gas passing from one chamber to the other, with variable partial vapor pressures, the two chambers remaining at an approximately constant uniform total pressure.

According to a combination of the general process defined above and its second particular feature, a second particular multiple-effect distillation process is characterized in that:

hollow and flat heat exchange elements, possessing at least one outer wall ensuring that any liquid flowing over said walls is spread out substantially uniformly, by gravity and/or capillary effect, are placed, so as to be vertical or inclined, in two thermally insulated treatment chambers that communicate via the top and via the bottom, the said chambers being assigned to liquid evaporation and to vapor condensation respectively, in such a way that these elements are separated in pairs therein by a narrow open space, of approximately constant width, which is filled with a noncondensable gas;

a heat transfer liquid is heated in a boiler and made to circulate in a closed circuit downward inside the elements of the evaporation chamber, then, after being cooled slightly, upward inside the elements of the condensation chamber and finally brought back to the boiler;

preferably hot liquid to be distilled spills at the top of the outer walls of the elements of the evaporation chamber and flows uniformly along these walls;

a stream of gas saturated with vapor circulates in a closed circuit between the heat exchange elements, flowing downward from the top of the condensation chamber and then upward from the bottom of the evaporation chamber;

a defined flow of cold liquid to be distilled continuously generates the flow of liquid spilled over the heat exchange elements of the evaporation chamber;

the distillate is collected at a bottom point of the condensation chamber; and

the concentrate is collected at a bottom point of the evaporation chamber.

According to a third particular feature of the general process defined above, the evaporation of the liquid is carried out on one or more hot surfaces, operating at a nonuniform temperature, and the condensation of vapor carried out on one or more other surfaces placed opposite the previous one(s), operating at an overall colder nonuniform temperature, the various regions of the evaporation and condensation surfaces being locally maintained at the required temperatures by virtue of the countercurrent circulation of a heat transfer fluid, a hot source being placed between the hottest ends of the evaporation and condensation surfaces and a cold source, installed between their coldest ends, the differences in partial saturation vapor pressures between the various regions of said surfaces being ensured by the presence of a noncondensable gas in a treatment chamber, at uniform total pressure.

According to a combination of the general process defined above and its third particular characteristic, a third particular multiple-effect distillation process is characterized in that:

hollow and flat heat exchange elements, possessing at least one outer wall suitable for ensuring that any liquid flowing thereon is substantially uniformly spread out, are installed, so as to be inclined or vertical, in a thermally insulated treatment chamber in such a way that these elements are separated in pairs by a narrow space, of approximately constant width, which is filled with a noncondensable gas;

the elements are distributed in two groups, assigned to liquid evaporation and to vapor condensation respectively, each condensation element being placed between two evaporation elements;

a heat transfer liquid is heated in a boiler and made to circulate in a closed circuit downward inside the evaporation elements, then, after being cooled slightly, upward inside the condensation elements and finally brought back to the boiler;

preferably hot liquid to be distilled spills at the top of the outer walls of the evaporation elements and flows uniformly along these walls;

a determined flow of cold liquid to be distilled continuously generates the flow of liquid spilled at the top of the outer walls of the evaporation elements;

the distillate is collected at the bottom of the walls of the condensation elements; and

the concentrate is collected at the bottom of the walls of the evaporation elements.

According to a complementary feature of these second and third particular distillation processes, the heat transfer liquid circulating in a closed circuit is the liquid to be distilled and the cold liquid to be distilled is added to the first liquid, at the point in the circuit where it is coolest.

According to another complementary feature of these two particular processes, the cold liquid to be distilled is preheated by heat exchange with the concentrate and/or the distillate.

According to another complementary feature of these two particular processes, the boiler is installed beneath the treatment chamber(s), and the distance between the boiler and the treatment chamber(s) is sufficient to allow the heat-transfer liquid to circulate by a thermosiphon effect.

According to a complementary feature of the previous one, applied to the production of fresh water, the boiler is a solar water heater, with or without accumulation, provided with a surface for absorbing solar radiation and, if appropriate, with an associated reservoir, said surface then being oversized with respect to the treatment capacity of the elements of the chamber and the volume of the reservoir very much greater being than the total internal volume of these elements.

By virtue of these arrangements, a second particular high-performance distillation process is defined, this differing mainly from the first process by the presence of an intermediate heat transfer liquid circuit between a condensation chamber and an evaporation chamber, both chambers being equipped with suitable heat exchange elements. This makes it possible to retain a simple fan for making the air circulate between the two chambers, but may mean having to use a pump, of comparable power consumption, to make this heat transfer liquid circulate in a closed circuit at a relatively low speed and at a relatively constant pressure. However, it will be noted that this fan itself may be omitted if the top and bottom respective openings for communication between the two chambers are long enough and wide enough to allow the air to circulate simply by natural convection between two chambers containing air at different temperatures. As regards the circulation pump for the heat transfer liquid, this itself may also be omitted when the boiler is placed beneath the treatment chamber, so that said boiler itself ensures such circulation, by the thermosiphon effect. Furthermore, the boiler must produce only hot liquid, it being understood however that the production of vapor therein is also possible, but in general of no particular benefit. If the heat transfer liquid is the liquid to be distilled, it should be noted that the slight cooling, designed to be carried out between the two bottoms of the elements of the two chambers, may be accomplished by the cold liquid to be distilled. In this case, two functions are then fulfilled, namely that of causing the flow of liquid spread out on the evaporation elements and that of cooling the mixture. In the case in which the temperature of this cold liquid will have been increased by prior heat exchange with the condensate or the distillate, the equilibrium temperature of the plant in question will be raised. This will make it possible, all other things being equal, to increase the performance coefficient of this plant.

The third particular distillation process according to the invention is a useful improvement of the second process since, in this third process, the heat exchange elements assigned to water evaporation and to vapor condensation respectively, are no longer installed in two separate chambers isolated from each other, dedicated respectively to these two functions, but on the contrary in a single treatment chamber in which the condensation elements are installed between two evaporation elements. This makes it unnecessary to use a fan to circulate a stream of saturated hot air between the condensation and evaporation elements since water vapor is produced from top to bottom of an evaporation surface placed a very short distance from a condensation surface, being at every level a few degrees lower. Consequently, the vapor produced at each level is transported transversely just by the effect of natural diffusion through a thin layer of saturated hot air at ambient pressure.

The advantages of these second and third particular distillation processes according to the invention are particularly useful when the boiler is a solar water heater with accumulation, oversized with respect to the instantaneous treatment capacity of the heat exchange elements employed. In this case, accumulation of hot seawater takes place in the reservoir during a six hours of strong sunlight during a day, thereby allowing a still according to the invention, comprising one (or two) treatment chamber(s) of limited operational capacity, to operate day and night and allowing its daily production of fresh water to be more than tripled.

However, it will be noted that the first particular distillation process according to the invention has, compared with the other two, the advantage of employing, for a given daily production, half the number of heat exchange surfaces. This is because, unlike the other two processes, each heat exchange element possesses two functions, namely that of condensing vapor on its inner walls and that of evaporating liquid on its outer walls. This may readily compensate for its drawbacks.

If the three distillation processes according to the invention are compared with the abovementioned MSF process, which comprises a succession of several chambers operating at temperature and saturation vapor pressure levels that decrease in stages, it is observed that these various chambers are in this case replaced with the various horizontal layers of the spaces separating the heat exchange elements in question. In the treatment chamber of the first and third processes according to the invention, the total pressure therein is atmospheric pressure and the temperature of the layers of the separating spaces in question decreases continuously from the top down to the bottom of the heat exchange elements. This results, between these layers, in a continuous decrease in partial saturation vapor pressure, the stability of which is ensured by the presence in an increasing amount of a noncondensable gas (generally air). The presence of this air in the treatment chamber of the two distillation processes according to the invention (whereas this air is continuously removed into the successive chambers of the MSF plants) is used as a means of varying the partial water vapor pressure along the countercurrent heat exchange walls, which walls thus experience, over their entire length, a suitable continuous double temperature variation. Similar considerations apply to the two chambers of the second process according to the invention.

In the three distillation processes according to the invention, the outputs of the distillation are very similar. The magnitude of the outputs delivered by these processes is a relatively complex function of many parameters and especially (1) of the temperature of the saturated hot air introduced into the elements or of the hot liquid entering the evaporation elements; (2) of the absolute temperature differences existing between the upstream end and the downstream end of the elements; (3) of the ratio of the total surface area of the elements to the boiler thermal power used; (4) of the flow rate of the hot liquid spilled, per unit area of the evaporation elements; (5) of the flow rate of the liquid and/or of the air circulating per unit area of the various elements; (6) of the width of the spaces filled with noncondensable gas that separate these elements; (7) of the drop in temperature created during the cooling; (8) of the rise in temperature of the liquid and/or the air, produced by the boiler; and finally (9) of the coefficient of thermal coupling of the treatment chambers and of the lines in question with the outside.

The values of several of these various parameters depend on one another within relatively complex relationships. In this regard, it will be noted, for example, that the difference between the temperature rise produced by the boiler and the temperature drop produced by the chiller is directly determined by the relatively high value of the heat losses of the system thus formed. This means that this difference (which is readily measurable) is representative of the coefficient of thermal coupling (which is relatively difficult to measure or to calculate) of the system with the outside, and of the efficiency factor of the heat exchange elements used. This is why the optimum values of the independent and non-imposed parameters of any still, constructed according to one of the distillation processes of the invention, will be determined from experimental data and from mathematical modeling of the thermodynamic system thus formed.

When it is correctly optimized, taking into account the imposed values of certain parameters, a seawater distillation plant, employing one or other of the three processes according to the invention, can produce from ten to fifty liters of fresh water per kWh (thermal) consumed, that is to say approximately from seven to thirty-five times the volume of water evaporated by this same power. The distillation processes according to the invention obviously achieve exceptionally effective recycling of the latent heat of condensation of the vapor.

In order for the various distillation processes defined above to be implemented effectively, suitable heat exchange elements are necessary.

According to the invention, such a heat exchange element is characterized in that it is hollow and flat, and in that at least one of its outer walls is provided with means for effectively spreading out the flow, by gravity and/or capillary effect, of a liquid spilled over this wall, which wall may be substantially flat or cylindrical.

According to a complementary feature of such a heat exchange element, said means for spreading out the flow consist either of a hydrophilic or wettable, permeable fabric or agglomerate, or of narrow or wide, shallow, parallel troughs intended to be placed horizontally.

According to further complementary features, such an element is mechanically stable in the presence of relatively hot liquids at below 100° C. and it constitutes a set of long juxtaposed conduits having outer walls that conduct heat well, said set being provided (1) with upstream couplers and downstream couplers that emerge in connection members; (2) with fitting means suitable for allowing said conduits to be placed vertically or at any suitable angle of inclination; and (3) with rigid lateral reinforcements, especially those suitable for determining the spacing of the assembly of juxtaposed elements.

According to a first embodiment, such an element is a rectangular flexible sheet, grouping together numerous narrow conduits that are formed between parallel longitudinal weld seams, these being produced between two polymer membranes, having, at least on the external side, a hydrophilic coating that is welded or adhesively bonded, and said couplers are formed by two transverse weld seams, produced upstream and downstream of said conduits.

According to a second embodiment, such an element is a rigid cellular rectangular panel provided with a hydrophilic or wettable outer coating, which is welded or adhesively bonded, and each of its upstream and downstream couplers forms a kind of elongate flat cover, having thin walls, said cover being fitted over the ends of this panel and sealably fixed thereto.

According to a third embodiment, such an element is a hollow and flat rigid rectangular panel possessing outer walls that are good heat conductors, these being provided with shallow parallel troughs placed transversely, these troughs being either narrow when this element has to be installed vertically, or wide when it has to be placed in a slightly inclined plane.

As examples, in a heat exchange element according to the invention, (1) such a permeable agglomerate will be a hydrophilic cellulose felt or a nonwoven or else a wettable sheet of porous sintered powder; (2) such a permeable woven will be made of hydrophilic cotton or of wettable impermeable yarns; and (3) such walls provided with troughs will be made of metal or of extruded hard plastic or else of thermoformed plastic. It should be noted that walls with troughs, which are relatively easy to clean, will preferably be used when the liquid to be distilled has a tendency to produce scale.

By virtue of these arrangements, such heat exchange elements become very appropriate for effective implementation of the distillation processes according to the invention. This is because the circulation of a stream of hot liquid in such a hollow and flat element, whether inclined or vertical, makes it possible to deliver, with little loss through its wall, being a good heat conductor, an amount of heat sufficient to ensure continuous evaporation of a substantial portion of any generally hot liquid flowing substantially uniformly over this wall as thin films, by gravity and/or capillary effect (as opposed to trickling that generally occurs in several separate flows, of variable thickness). The reverse process also exists. This is because, when hot air saturated with vapor surrounds such a vertical or inclined element and when the latter is traversed from the bottom upward by a less hot liquid, vapor condensation takes place on the walls of this element. The consequence of this phenomenon is the excellent transmission of the heat of condensation of this vapor to said liquid, which is heated up as it rises and as the distillate slowly descends as a thin film, by capillary effect and gravity, in a hydrophilic or wettable coating or from one trough to another. Consequently, this type of heat exchange element according to the invention can, by ignoring the entropy increases in question, be termed a quasireversible heat-exchange element.

The features and advantages of the invention will become clearer after reading the following description of various embodiments of heat exchange elements and of improved distillation plants making use of these elements, which embodiments are given by way of nonlimiting examples with reference to the appended drawings in which:

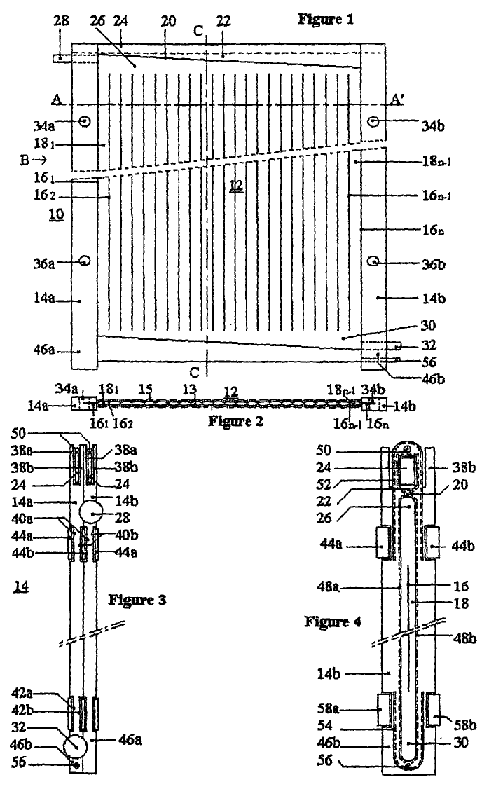

FIG. 1 shows a schematic front view of a flexible heat exchange element according to the invention;

FIG. 2 shows a cross-sectional view of this flexible element;

FIG. 3 shows an end view of two juxtaposed flexible elements installed in a treatment chamber;

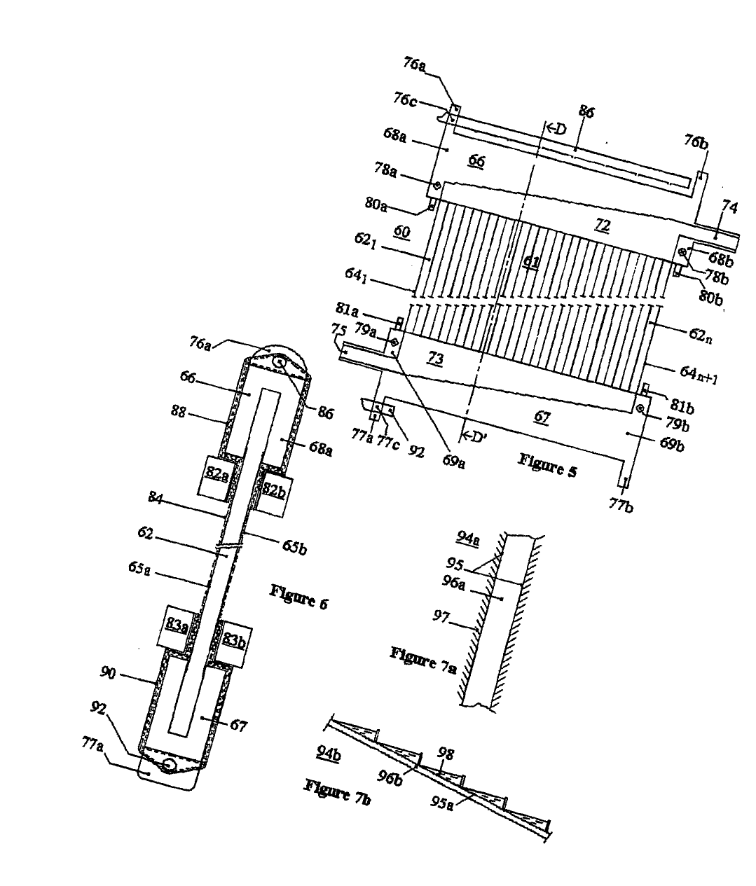

FIG. 4 shows a longitudinal sectional view of a flexible heat exchange element;

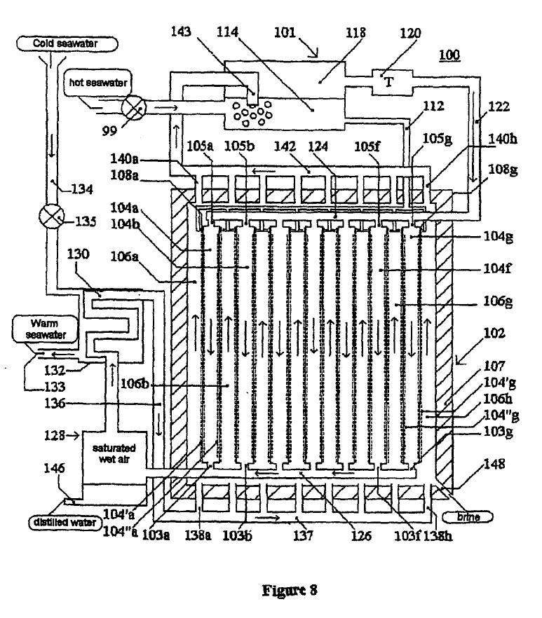

FIG. 5 shows a schematic front view of a rigid heat exchange element according to the invention;

FIG. 6 shows a longitudinal sectional view of this rigid element;

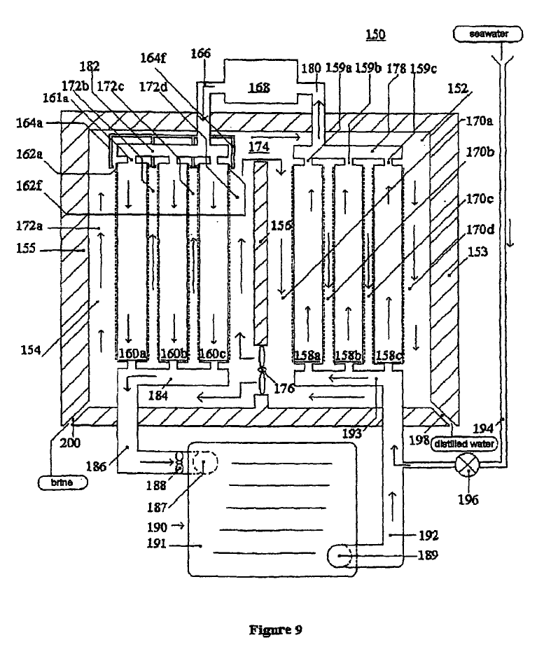

FIG. 7 shows a partial longitudinal sectional view of a heat exchange element provided with narrow troughs;

FIG. 8 shows, in schematic form, a plant implementing the first process according to the invention for distillation of hot seawater discharged by a marine engine;

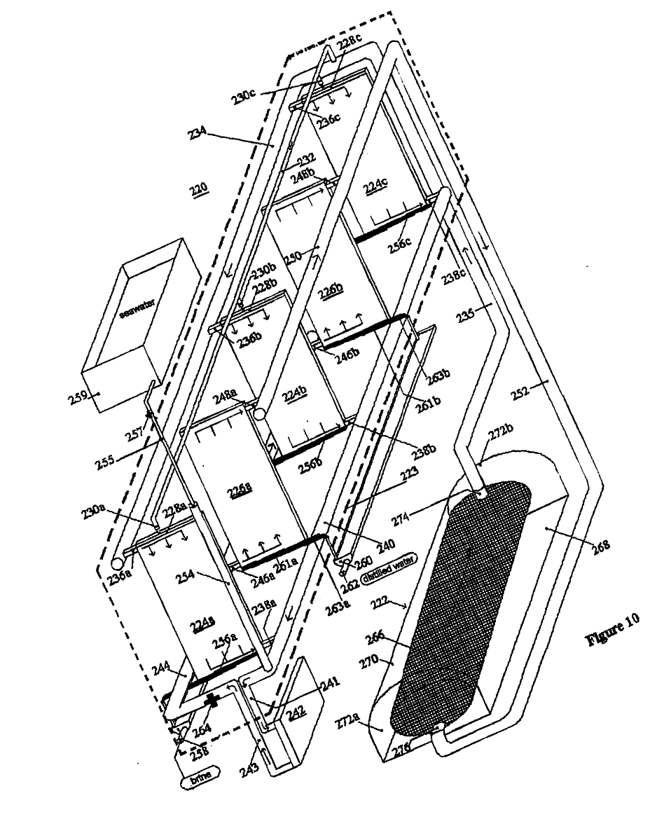

FIG. 9 shows, in schematic form, a plant implementing the second process according to the invention for distillation of seawater using a conventional boiler; and

FIG. 10 shows, in a simplified perspective view, a plant, equipped with a solar boiler with accumulation, implementing the third process according to the invention for distillation of seawater.

According to FIG. 1, and FIG. 2 which is a sectional view on the line A-A′ in FIG. 1, a first type of heat exchange element 10 essentially comprises a flexible sheet 12 provided with rigid lateral reinforcements 14a-b made of molded plastic. The sheet 12 is made from a thin membrane 13 made of food-grade plastic, for example polyethylene 100 μm in thickness, and it includes a welded hydrophilic coating 15, consisting of a cellulose nonwoven of similar thickness. To produce the sheet 12, the membrane selected is firstly folded in two, the coating 15 being placed on the outside, then subjected to one or more welding operations so as to form a large number of parallel longitudinal weld seams 16₁ . . . 16n. The end seams 16₁ and 16n are approximately 30 mm in width and extend over the entire length of the sheet 12. The other seams are from 2 to 3 mm in width, are separated from one another by distances of 15 to 20 mm and stop short of the ends of the sheet by approximately 15 cm. In a given sheet 12, the number of conduits 18₁ . . . 18ₙ₋₁ thus formed may reach some fifty or so, the width of the sheet 12 possibly varying from 60 to 120 cm and its length from 80 to 180 cm, depending on the application envisioned. A transverse and slightly oblique weld seam 20 is produced near the fold in the membrane and, slightly above this seam 20, two lateral cutouts, of width slightly greater than the width of the lateral reinforcements 14a-b, are made in the extensions of the end weld seams 16₁ and 16n. In this way, a sheath 22 is produced which will have, for example, a width of 50 mm at one end and 80 mm at the other. A flat rod 24, having rounded edges, 40 mm in width and 4 mm in thickness, to enable the element 10 to be suspended vertically, can be inserted into this sheath 22. The transverse weld seam 20 joins up with the end seams 16₁ and 16ₙ so as to define a flat coupler 26, in the form of a trapezoid measuring 20 mm above the conduit 18, and 50 mm above 18ₙ₋₁. Coming out above the line 16ₙ is a connection tube 28 fixed in a sealed manner to the wide end of the coupler 26, which measures at most 12 mm in outside diameter and about 60 mm in length. A coupler 30, symmetrical with the coupler 26, is produced at the lower end of the conduits 18₁ . . . 18ₙ₋₁ and this coupler 30 is connected to a connection tube 32 diagonally opposite but identical to the previous one. The rigid lateral reinforcements 14a-b incorporate the wide end weld seams 161.

According to FIG. 2, the conduits 18₁ . . . 18n−1, bounded by the membrane 13 and its coating 15, appear slightly inflated, each having the shape of two circular arcs, with a maximum separation of 4 mm, joined together by a weld seam 162 . . . 16n−1. After this swelling, the initial width of the sheet 12 is reduced by about 5%. Two pairs of clamping rods are designed to be inserted into two holes 34a-b and 36a-b made in each of the reinforcements 14a-b, which clamping rods are fastened to a suitable frame (not shown) and will allow the various elements 10, assembled in a treatment chamber, to be correctly positioned. The distance between two clamping rods, fixed at the same level to the inner frame of a treatment chamber, will be equal to the initial width of the sheet, reduced by the 5% mentioned above.

FIG. 3 shows an end view, looking along the arrow B, of the rigid lateral reinforcements 14a and 14b of two flexible-sheet heat exchange elements 10 juxtaposed so that their connection tubes 28 and 32 have reverse positions, in order to allow them to encroach on the neighboring element. Each reinforcement 14a and 14b extends the coupler 26 upward, so as to form a two-branch fork 38a-b. At each coupler 26 and 30 for the conduits of the sheet 12, the reinforcements 14a and 14b have on each side two lateral cutouts 40a-b and 42a-b. To give examples, the thickness of each reinforcement 14a or 14b will be 7 mm, its width will be 40 mm, the thickness of the branches 38a-b of the fork will be 1.5 mm, the spacing of these branches will be 4 mm, their height will be 44 mm, the depth of the cutouts 40a-b and 42a-b will be 1.65 mm and their height will be 60 mm. The support formed by the branches 38a-b is intended to house, so as to bear on them, one of the ends of the suspension rod 24. Each pair of cutouts 40a-b and 42a-b of the lateral reinforcements 14a-b of two juxtaposed elements 10 is intended to serve as a housing for one of the ends of two intermediate plates 44a-b made of cellular plastic, having a thickness of 3 mm, a width of 60 mm, and a length equal to that of the rod 24. The reinforcements 14a-b extend the coupler 30 downward, to form the two respective feet 46a-b of the heat exchange element 10, these feet 46a-b being intended to rest on the bottom of the treatment chamber or chambers of the still. Coming out slightly above the feet 46a-b are respectively the connection tube 32 and a discharge pipe 56 which will be presented below.

In FIG. 4, which is a sectional view on the line C-C′ of the sheet 12 (with a lateral separation of the various components in order to make it easier to show them), the seam 16 represents a weld seam and the broken lines 48a-b represent the composite walls (internal plastic membrane and external hydrophilic coating) of a conduit 18. The coupler 26, the transverse weld seam 20, the sheath 22 and the suspension rod 24 may be seen above the seam 16. Placed above and over the entire length of the rod 24 are a 4 mm wide pipe 50, blocked at its free end and pierced with a 1 mm diameter hole every 10 cm, and a cover 52 made of a composite material (inner hydrophilic coating and outer plastic membrane) which envelops the pipe 50, the rod 24 and the coupler 26 and which comes down over the first few centimeters of the conduit 18. Likewise, a shoe 54 is placed at the base of the sheet 12, said shoe being similar to the cover 52 and installed like it, so as to envelope the coupler 30 and the last few centimeters of the conduit 18. The shoe 54 has a slight slope, terminating in a discharge pipe 56, fastened in a sealed manner, which comes out above the foot 46b of the rigid lateral reinforcement 14b (see FIG. 1). The two plates 44a-b or 58a-b made of cellular plastic are pressed in their housing by the lateral reinforcements 14a-b of the two elements which surround the element 10 shown. Consequently, the couplers 26 and 30, which when inflated would extend beyond the space assigned to them, are confined and, in the case of the example shown above, reduced to a thickness of 3.7 mm. In addition, the cover 52, which applies its inner hydrophilic coating against the outer hydrophilic coating of the sheet 12, cooperates with the pipe 50 for feeding water to be distilled, in order to distribute this water uniformly, by capillary effect and gravity, in the hydrophilic coating of this sheet. Under these conditions, an open space having an average thickness of 3.3 mm is left between the flexible sheets 12 of two juxtaposed elements 10. This open space is extended, at the top and the bottom of the elements 10, by the transverse cells (squares of 3 mm a side) of the plates 44a-b and 58a-b, thus ensuring that there is a free open space of suitable width between two juxtaposed elements 10.

FIG. 5 and FIG. 6, which represents a sectional view on the line D-D′ of FIG. 5, show a second heat exchange element according to the invention. FIG. 5 is a schematic view of a rigid heat exchange element 60 produced from a cellular panel 61, made of food-grade plastic, for example polypropylene, of a commercially available type, especially for forming display supports. To give an example, such a panel 61 measures 60 cm in width and 80 cm in length and comprises about 180 longitudinal cells such as 62₁ . . . 62ₙ of square internal cross section 3 mm a side, said cells being bounded by narrow partitions 64₁ . . . 64ₙ₊₁ and faces 65a-b (see FIG. 6), 0.15 mm in thickness. The top and bottom ends of the panel 61 are inserted into and welded in a sealed manner to two identical elongate flat cover plates 66 and 67, placed symmetrically, made of a plastic identical to that of the panel 61. Each cover plate 66-67 includes two lateral reinforcements 68a-b and 69a-b, 7 mm in thickness, 20 mm in width and 80 mm in height. In the central part of the cover plates 66 and 67, two trapezoidal flat headers 72 or 73 run into two diagonally opposed connection tubes 74 or 75. The reinforcements 68a-b and 69a-b include, on the one hand, extensions 76a and 77a pierced with a hole 76c and 77c and, on the other hand, extensions 76b and 77b, the extensions 77a-b serving as feet for the element 60. Furthermore, two pairs of holes 78a-b and 79a-b, through which the two pairs of rods for clamping the elements 60 are intended to pass, installed in a treatment chamber. Finally, the reinforcements 68a-b and 69a-b are provided on each side with U-shaped tongues 80a-b and 81a-b designed to facilitate the fitting of the intermediate plates 82 and 83 of FIG. 6.

This FIG. 6 shows a cell 62 and its two outer faces 65a-b inserted into their end cover plates 66 and 67. The faces 65a-b of the cells of the panel 61, together with the external walls of the cover plates 66 and 67, have an adhesively bonded hydrophilic coating 84, represented by the dotted lines. A pipe 86, identical to the pipe 50 in FIGS. 3-4 intended for feeding seawater into the element 60, passes through the hole 76c of the extension 76a, runs above the cover plate 66 and stops, blocked, approximately at the end of the cover plate 66. A cover 88, identical to the cover 52 in FIG. 4, covers this pipe 86 and that part of the cover plate 66 between the extensions 76a-b, going down as far as the panel 61. Likewise, a shoe 90, identical to the shoe 54 in FIG. 4, is installed between the feet 77a-b of the element 60—it starts from the bottom of the panel 61 and terminates, with a slight slope, under a discharge conduit 92 inserted into the hole 77c of the foot 77a of the element 60. The end cells of two pairs of intermediate plates 82a-b and 83a-b, 60 mm in width, produced from a panel identical to panel 61, engage with the U-shaped tongues 80a-b and 81a-b of each of the reinforcements 68a-b and 69a-b of two juxtaposed elements 60. In this way, the internal hydrophilic coatings of the cover 88 and of the shoe 90 are pressed against the external hydrophilic coatings 65a-b of the panel 61 and of the cover plates 66 and 67. Under these conditions, the cover 88 ensures that the water to be distilled, supplied via the trough 86, is properly distributed, by capillary effect and gravity, in these external coatings. As regards the shoe 90, depending on whether it is installed on evaporation plates or on condensation plates, it ensures proper collection of the brine or of the distilled water that flows out of these same coatings. Furthermore, these pairs of intermediate plates 82a-b and 83a-b establish, between two juxtaposed elements 60 assembled in a treatment chamber, a suitable open free space which, in the present case, has a width of 3.3 mm.

FIGS. 7a and 7b show views, in partial longitudinal section, of a vertical heat exchange element 94a and a slightly inclined heat exchange element 94b. They are rectangular, hollow and flat, with internal cells 96a-b and two walls 95 provided with narrow troughs 97 in the case of one of the elements, and a single wall 95a provided with wide troughs 98, arranged in cascade, in the case of the other element. The planarity of these walls is ensured by the presence of internal spacers separated by a few decimeters. The surface area of these elements may be relatively large, for example more than one square meter. The width of the troughs will be a few millimeters in the case of the narrow ones and about one decimeter in the case of the wide ones, their depth will be a few millimeters, and the distance separating the narrow ones will be a few centimeters. A trough for feeding the liquid to be distilled, identical to the troughs 50 and 86 in FIGS. 4 and 6, will be installed above these elements, but no flow distributing cover will be necessary. Suitable troughs will be provided for collecting the condensate. These elements may be made from sheets of metal or of hard plastic, these being produced by extrusion, provided with narrow or wide troughs. They will be joined together by means of suitable borders and of spacers. Another way of producing such a heat exchange element with narrow troughs will be to use the techniques for manufacturing hollow thermoformed plastic bodies.

FIG. 8 shows schematically a distillation plant 100 for implementing the first high-performance distillation process according to the invention. This plant 100 comprises a thermally insulated reservoir 101 containing hot water and vapor. It is fed via a conduit provided with a flow-regulating valve 99, conveying 2 m³ of hot seawater at 95° C. per hour, this water being discharged by the marine engine (not shown) of a small coastal power station, which thus cogenerates electricity and fresh water. This reservoir 101 is installed above a treatment chamber 102, in the form of a tank with a 150×350 cm rectangular bottom and 170 cm in height. The treatment chamber 102 has thick walls 107, thermally well insulated, and it contains a frame (not shown) on which are installed, and fixed via their assembly rods (not shown), four hundred heat exchange elements 100 cm in width and 120 cm in height, such as 104a . . . g. These elements are of the flexible-sheet kind shown in FIG. 1, but they differ therefrom by the fact that they also include an internal hydrophilic coating 104″a . . . g identical to their usual external hydrophilic coating 104′a . . . g, both being shown as dotted lines. These elements are separated from one another by 3.3 mm thick intermediate cellular plates (not shown), labeled 44a-b and 58a-b in the FIGS. 3 and 4. As indicated above, they are assembled and juxtaposed by two pairs of assembly rods passing through their rigid lateral reinforcements, so as to create free spaces 106a . . . h open from top to bottom. The pipe 50 and the cover 52 of FIG. 4 are placed (but not shown here) on the upper layer of each element 104a . . . g, this pipe being connected to a conduit 112 fed with the hot seawater 114 contained in the reservoir 101.

The upper part of the reservoir 101 is filled with hot air 118 saturated with water vapor. A turbine 120, joined to this upper part, is connected by a pipe 122, about 20 cm in diameter, to a header 124 which is connected to the connection tubes of the top couplers 105a . . . g of the heat exchange elements 104a . . . g. In the case of a hot water flow rate of 2 m³/h, this turbine 120 generates a 0.4 m³/s flow of air at a speed of about 15 m/s and at a pressure of 3 hectopascals. The hot air saturated with vapor, thus injected into the conduits of these elements, passes through them from the top down, at a relatively high speed. A downstream header 126, joined to the connection tubes of the bottom couplers 103a . . . g of the elements 104a . . . g, is connected to the inlet of an air/water segregation tank 128. The bottom inlet of a vertical coil 130, immersed in the water of a cooling tank 132, is connected to the top part of the air/water segregation tank. The tank 132 has a top inlet, fed with seawater at the external temperature (about 25°) via a conduit 134, provided with a flow-regulating valve 135. The tank 132 has a bottom outlet 133 for discharging warm (about 40° C.) seawater. The top outlet of the coil 130 is joined, via a conduit 136, to a header 137 connected to several bottom inlets, such as 138a . . . h extending slightly from the bottom of the treatment chamber 102. The dried and cooled air thus injected into the chamber 102 is at a temperature of about 40° C. This chamber 102 has several top outlets, such as 104a . . . h, connected to a header 142 whose upper end 143 is immersed in the water 114 of the reservoir 100. The segregation tank 128 has, at a bottom point, a pipe 146 for discharging the fresh water condensed in the cells 104a . . . g and in the coil 130. The treatment chamber 102 has, at a bottom point, a pipe 148 for discharging the brine.

FIG. 9 shows in schematic form a distillation plant 150 produced according to the second process of the invention. This plant 150 comprises two treatment chambers 152 and 154 provided with thick walls 153-155, thermally well insulated, and separated by an insulating central partition 156. These chambers 152-154 are assigned to vapor condensation and to water evaporation respectively. The system, formed by these two contiguous chambers, constitutes a tank with a 60×80 cm rectangular bottom and a height of 120 cm. The condensation chamber 152 contains fifteen or so “cold” heat exchange elements, such as 158a,b,c, which measure 60 cm in width and 80 cm in height and are provided with lateral reinforcements 7 mm in thickness. These elements are provided with hydrophilic coatings (shown by the dotted lines, but not labeled) and comprise either flexible sheets according to FIGS. 1, 2 and 3 or rigid cellular panels, of the kind described in FIGS. 5 and 6. The evaporation chamber 154 also contains fifteen heat exchange elements identical to the previous ones, such as 160a,b,c, but the latter elements are hot and differ from the cold panels 158a,b,c by the fact that they are provided on their upper part with hot water spreading covers 162a . . . f that cover the top of the hydrophilic coatings. These covers cover troughs such as 164a . . . f, for feeding seawater (cf. the pipe 86 and the cover 88 in FIG. 6), which are connected to the outlet conduit 166 of a boiler of 1 kW thermal power which includes a reservoir 168 filled with seawater heated to about 95° C. The heat exchange elements 158a,b,c and 160a,b,c are separated from one another by open spaces 170a . . . d and 172a . . . d having a width of 3.3 mm (cf. FIG. 6).

The tops of the open spaces 170a . . . d and 172a . . . d communicate with one another through a relatively wide passage 174 provided over the entire upper part of the central partition 156 that separates the condensation chamber 152 from the evaporation chamber 154. The bottoms of the open spaces 170a . . . d and 172a . . . d also communicate with one another through a circular passage provided in the lower part of the partition 156, in which passage a fan 176 is installed. This fan 176 is suitable for injecting, into the evaporation chamber 154, a stream of dried and cooled air coming from the condensation chamber 152 and thus for making a stream of air circulate in a closed circuit in these two chambers. The fan 176 produces, in the case of a 1 kW boiler, a flow rate of about 80 liters/s and the speed of the air blown between the elements is about 40 cm/s.

The connection tubes of the top couplers 159a,b,c of the cold heat exchange elements 158a,b,c of the condensation chamber 152 are joined to a header 178, which is connected to a conduit 180 that passes through the horizontal upper part of the wall 153 and terminates in the inlet of the reservoir 168. The outlet conduit 166 of this reservoir 168 passes through the horizontal upper part of the wall 155 of the evaporation chamber 154 and terminates in a header 182 to which the connection tubes of the top couplers 161a,b,c of the hot heat exchange elements 160a,b,c are joined. The connection tubes of the bottom couplers of the hot elements 160a,b,c are joined to a header 184 which is connected to a conduit 186 that passes through the lower part of the wall 155 of the chamber 154 and terminates in the inlet of a pump 188. This pump 188 feeds a chiller 190, exposed to the ambient air and placed in the shade, from which chiller a conduit 192 runs, said conduit 192 passing through the lower wall 153 of the condensation chamber 152 and terminates in the bottom header 193 of the cold elements 158a,b,c of this chamber 152. The pump 188 makes the water flow at a speed of 1 to 2 mm/s through the cells of the heat exchange elements. Connected to the conduit 190 is the bottom end of a column 194 open to the air slightly above the reservoir 168 and provided with a flow-regulating valve 196. This column 194, fed with seawater at the external temperature and this valve 196 are suitable for adding, to the seawater circulating in a closed circuit in the heat exchange elements 158a,b,c and 160a,b,c of the two chambers 152 and 154, a given flow of seawater at the external temperature, adjusted according to the optimum values of the operating parameters of the plant (i.e. about 10% of the flow produced by the pump 188). A conduit 198, for discharging the fresh water produced, passes through a side wall of the condensation chamber 152 at the bottom of this chamber. Another conduit 200, for discharging the brine, passes through a side wall of the evaporation chamber 154 at the bottom of this chamber.

The chiller 190 is a heat sink 191 placed in the shade, which may be made from a sheet of polyethylene, provided with internal weld seams and with an external hydrophilic coating kept constantly wet by seawater. This chiller, whose purpose is to lower the temperature of the seawater passing through it by a few degrees (generally 3 to 7° C.), has a surface area that depends on the temperature of the dew point of the ambient air. As an indication, in the desert the latter temperature is close to 15° C., in dry coastal regions it approaches 23° C. and in hot wet regions it rises up to 30° C.

FIG. 10 shows the diagram of a domestic seawater distillation plant 220 produced according to the third process of the invention. The plant 220 comprises, as a nonlimiting example, an accumulation-type solar boiler 222 installed beneath a thermally insulated treatment chamber 223 (shown schematically in dotted lines) with an 80×60 cm rectangular bottom and a height of 120 cm. In this chamber are twenty-five heat exchange elements 60 cm in width and 80 cm in height, these being provided with 7 mm thick lateral reinforcements of one of the kinds described in FIGS. 1 to 4 or 5-6. These elements are distributed in a first group and in a second group, assigned to water evaporation and to vapor condensation respectively. As shown in FIG. 4 or 6 (but not transferred into FIG. 10), the thirteen evaporation elements, such as 224a,b,c, are provided with a seawater feed trough 50 or 86, a cover 52 or 88 for distributing this water and a shoe 54 or 90 for collecting the brine. As for the twelve condensation elements, such as 226a-b, they are only provided with a shoe 54 or 90 for collecting the distilled water produced. Each condensation element is inserted between two evaporation elements, with a gap of 3.3 mm, thanks to the lateral reinforcements 14a-b and to the presence of the intermediate plates, such as 44a-b in FIG. 5 (not shown here). The array of these heat exchange elements is in principle suitable for treating hot seawater at a temperature varying from 60 to 75° C., delivered by a boiler having a thermal power of about 400 W. In fact, the number and the dimensions of the elements indicated above are approximate-systematic trials will have to be carried out in order to give them optimum values so as to optimize the coupling between treatment chamber and solar or conventional boiler.

The various pipes feeding hot seawater to the hydrophilic coatings of the evaporation elements 224a,b,c (labeled 50 and 86 in FIGS. 3 and 5) are in this case relabeled as 230a,b,c. They are connected to a header 232, which is joined to a conduit 234 connected to the outlet of the boiler 222 via a thermally insulated line 235. The top couplers of the evaporation elements 224a,b,c (the first group) are fed with hot seawater via connection tubes 236a,b,c joined to the conduit 234. The connection tubes 238a,b,c, fixed to the bottom couplers of these same evaporation elements, are joined to a header 240 which is extended by a conduit 241 that passes through the lower wall of the treatment chamber 223 and terminates in the inlet of a chiller 242, identical to the chiller 190 of FIG. 8 and installed likewise. The outlet of the chiller 242 is connected to a conduit 243 that passes through the lower wall of the chamber 223 and terminates in a header 244 feeding the connection tubes 246a-b of the bottom couplers of the condensation elements 226a-b (the second group). The connection tubes 248a-b of the top couplers of the condensation elements 226 a-b are joined to a header 250, which is connected to a thermally insulated line 252 joined to the inlet of the boiler 222. Also joined to the conduit 240 is a column 254, emerging in the open air slightly above the level of the conduit 232 for feeding hot seawater to be spread over the evaporation elements. Poured into this column 254 is a constant defined flow of seawater at the external temperature, delivered by a pipe 255 provided with a flow-regulating valve 257 and joined to a reservoir 259. This is itself preceded by a filter (not shown). This constant flow, which corresponds approximately to 10% of the flow circulating in the plant, generates the overflow of an equal amount of hot water coming from the boiler 222, spilled over the hydrophilic external walls of the evaporation elements 224a,b,c. Furthermore, this constant flow represents about twice the expected flow of fresh water and at least one and a half times this flow, so as never to deposit salt in the plant.

The shoe 90 and its pipe 92 shown in FIGS. 5 and 6, provided for collecting the brine which flows out of each of the hydrophilic coatings of the evaporation elements 224a,b,c, are shown here and labeled 256a,b,c. They are joined to a header 258, assigned to discharging this brine. A shoe 261a-b and a pipe 263a-b, identical to the previous ones, are placed on the condensation elements 226a,b and are joined to a header 260 connected to a pipe 262 for discharging the distilled water.

By installing the solar boiler 222 below the treatment chamber 223, in such a way that the outlet of this boiler is located at least 2 m below the header 232, feeding the evaporation elements 224a,b,c with hot water to be spread, a circulation, induced by the thermosiphon effect, of the hot water produced by the boiler is spontaneously established in the closed circuit formed in the distillation plant. The final mean velocity of this circulation is about 15 cm/s in the thermally insulated lines 235 and 252 and a few mm/s in the cells of the heat exchange elements. This velocity is regulated by a manually controlled valve 264 installed at the coldest point of the plant, namely at the start of the header 244 which feeds the bottom connection tubes 246a,b of the condensation elements 226a,b with cold water produced by the chiller 242.

The accumulation-type solar boiler 222 comprises an elongate reservoir 266 made of relatively thick (0.15 mm for example) black polyethylene measuring 40 cm in width, 30 cm in height and 3 m in length, which contains about 300 liters of water, i.e. roughly ten times the volume of water contained in the cells of the heat exchange elements 224-226. The reservoir 266 is, on the one hand, installed on an insulating platform 268 and, on the other hand, beneath a transparent covering 270, made of polyethylene treated so as to trap the infrared radiation, said covering being mounted in a sealed manner on transparent insulating rigid end plates 272a,b fastened to the platform 268. This platform 268 and reservoir 266 are oriented according to the latitude of the site in which the plant 220 is installed and are slightly inclined.

The bottom end of the thermally insulated hot water feed line is connected to a bung 274 fitted to the uppermost end of the reservoir 266. The thermally insulated cooled water return line 252 terminates in a bung 276 fitted to the lowest end of the reservoir 266. Such an accumulation-type solar boiler produces, during six hours of full sunlight during the day, hot water at about 75° C. Thanks to the plant's good thermal insulation, during the night this temperature drops slowly to about 60° C. As regards the temperature of the water returning to the boiler, this remains constantly about 4 to 6° C. below the temperature of the outflowing hot water. The plant 220 operates day and night, but the hourly production of fresh water decreases during the night, at the same time as the temperature of the hot water delivered by the boiler.

By virtue of these arrangements, the three distillation plants according to the invention described in FIGS. 8, 9 and 10 provide particularly promising results. This is due to the high efficiency of each of the quasireversible liquid/vapor heat exchange elements used, to the possibility of assembling them in a relatively small volume in order to form very large overall heat exchange surfaces and to the very small thickness of the air cavities that separate these elements. At each level of the walls of these heat exchange elements, the temperatures of the hot fluids flowing downward are slightly greater (at least greater than a theoretical threshold of about 0.5° C. in the case of seawater) than those of the “cold” fluids flowing upward.

In the plants for implementing the second and third processes according to the invention, about 10% of the water flowing in the conduits or the cells of the heat exchange elements is spread out over the hydrophilically coated walls of the evaporation elements. During its descent, by capillary effect and/or gravity, along the walls of these evaporation elements, about half and at most two thirds of the water thus spread out is evaporated then condensed on the hydrophilically coated walls of the condensation elements. To do this, the temperature of the hot water thus spread out progressively decreases from the top down, and likewise the temperature of the water which accompanies it and which flows from the top down in the conduits or the cells of the evaporation elements decreases, while the temperature of the water which flows from the bottom up in the condensation elements progressively increases, said condensation elements thus recovering the latent heat of condensation of the vapor. In the heat exchange elements of the plants according to the first process, saturated hot air replaces the water circulating in the elements of the other two, but the heat exchanges are similar.

It should be noted that the internal hydrophilic coating of the walls of the elements of the plant according to FIG. 8 (first process) and the hydrophilic or wettable external coating of the walls of the condensation elements of the plants according to FIGS. 9-10 (second and third processes) allow the small drops of pure water condensed on these walls to slowly descend giving up at the same rate their latent heat of condensation to the seawater flowing in the opposite direction on the outside or in the inside of these elements. Such a hydrophilic coating, applied to the cold walls of these elements, prevents the progressive formation of large drops of hot water at the top of the elements and then these same drops suddenly descending. This would appreciably reduce the degree of recycling of the heat of condensation of the vapor.

A temperature difference of several tens of degrees exists between the top and the bottom of the vapor-saturated air cavity present in the open spaces separating the heat exchange elements. The absolute pressure in these saturated air cavities is constant, whereas the partial water vapor pressure is high in their part close to the hot plates and substantially lower in their part close to the cold plates. As a result, there is natural diffusion of the water vapor molecules in these saturated air cavities, making these molecules leave a hot wall level, to condense on a cold wall located at the same level. In the case of the third distillation process according to the invention, the magnitude of this diffusion depends directly on the coefficient of energy transfer between the wall of a hot element and that of the cold element facing it. This coefficient increases when the distance between two opposed walls decreases and the partial water vapor pressure increases. In the temperature range in question (20 to 95° C.), it is between 50 and 500 W/k.m² and is always substantially greater than all the other forms of heat exchange between the elements (radiation, conduction through the air, convection). This allows very extensive water distillation to be carried out.

In the case of the third process, it should be pointed out that the heat exchange, which takes place from a hot wall to the cold wall of the heat exchange element facing it, is accompanied by an exchange of pure water across a kind of osmotic membrane consisting of the cavity of saturated wet air lying between these elements. However, the driving force for the exchange is not a pressure difference, established on either side of the air cavity by a pump, but a simple vapour pressure difference, resulting from the temperature difference, which is much easier to obtain, by inserting a boiler between the outlets of the cold-wall condensation elements and the inlets of the hot-wall evaporation elements.

As regards the thermal energy provided by the boiler, this ends up not only in the temperature difference existing between the warm liquids (the distillate and the concentrate) discharged by the plant and the liquid at the external temperature that enters it, in the power dissipated by the chiller and in the heat losses of the plant (the walls of the quasireversible heat exchange elements and the various treatment chambers and lines), but also in the work of separating the pure water from the brine, which determines the theoretical threshold of 0.5° C. mentioned above.

As regards the quasireversible liquid/vapor heat exchange elements of a distillation plant according to the invention, these treat and recycle quantities of thermal energy equivalent to up to fifty times that provided by the boiler. The resulting performance coefficient is higher the lower, on the one hand, the energy losses during the liquid/vapor and vapor/liquid double exchange between an ascending fluid and a descending fluid, separated by the thin wall of a heat exchange element, and, on the other hand, the losses through the thermally insulated external walls of the plant. Moreover, it should be noted that the theoretical value of this performance coefficient, which depends directly on the saturation vapor pressure of the hot water produced by the boiler, is equal to the ratio of the circulating water temperature differences generated by the heat exchange elements and by this boiler, respectively.

Consequently, seawater distillation plants comprising the features of one or other of the processes described above are both particularly effective and particularly economic. This is because, with inexpensive and compact heat exchange elements having two active faces according to the invention, it is possible to produce, in small volumes, particularly large surface areas for quasireversible liquid/vapor heat exchange, for example one thousand square meters installed in a container of less than 10 m³, in order to form the distillation plant according to FIG. 8. The production of fresh water by the seawater distillation plants produced according to one or other of the processes of the present invention is estimated to be between ten and fifty liters per kWh (thermal) used, according to the possible degree of optimization of the various parameters governing the operation of these plants. This gives a performance coefficient that may be between 7 and 35.

The three distillation processes according to the invention may be implemented by means of a solar or a conventional boiler. However, it should be noted that the distillation plants with a solar boiler are in general less productive, per unit of thermal energy used, than those with a conventional boiler. This is because the maximum temperatures of the hot water delivered by the boiler are very different in the two types of boiler and they constitute one of the major parameters determining the performance coefficient of the plant. With a solar boiler, the thermal power of which depends on external factors (the latitude of the installation site and the season), this maximum temperature is between about 65° C. and 75° C., whereas with a conventional boiler having an easily adjustable thermal power, it easily reaches 95° C.

Under these conditions, the valve 264 for regulating the flow of the hot water delivered by the solar boiler and the valve 257 that adjusts the feed with seawater to be distilled, which valves are provided for a distillation plant according to the third process of the invention, are particularly important. This is because, whatever the type of boiler used—conventional or solar, with or without accumulation—to maximize the performance coefficient of a distillation plant having fixed parameters (the number, height and width of the exchange elements, the width of the space separating them and the maximum thermal power of the boiler), means that the temperature difference between the flows of hot and less hot water leaving the boiler and those entering it must be as low as possible, whereas the temperature difference between the top and bottom of the heat exchange elements must, on the contrary be as high as possible. By acting on the valve 264 for regulating the flow of hot water, installed in the closed circuit that includes the boiler 222, the velocity of the thermosiphon-induced rise of this hot water in the feed line 235 for the hot heat exchange elements 264a,b,c is modified, and therefore also its rate of flow in the cells of these elements. The flow, by capillary effect and by gravity, of the hot water to be evaporated, spread out over the vertical hydrophilic coatings of the evaporation elements, depends on the flow rate permitted by the valve 257. The latter flow rate determines the overflow of the closed circuit, consisting of the heat exchange elements and the boiler. Above a first (high) threshold of this flow rate, it will be understood that the flow of water to be distilled in the hydrophilic coatings of the evaporation elements is too fast and takes place more by gravity than by capillary effect. This directly affects the heat transfer from the hot water flowing in the cells to the hot water spread out over their walls to be evaporated. This considerably reduces the hourly production of fresh water by the plant and unnecessarily increases the production of a barely concentrated brine. On the other hand, below a second (low) threshold of the flow rate of water to be distilled, the concentration of the brine may be too high and cause salt to be deposited, prejudicial to operating the plant correctly for a long time.

In the FIGS. 8 and 9, the distillation plants according to the invention incorporate conventional boilers and the valves, such as 99-135 (FIG. 8) or 196 (FIG. 9), are regulated once and for all. In contrast, with solar boilers, the valves 264 and 257 must be periodically adjusted in order to optimize the operation of the plant, according to the values of the external parameters mentioned above. In practice, it would be possible to have additional, manual or even automatic, means for slightly modifying these adjustments according to the main maximum temperature ranges of the hot water produced by the solar boiler, over the course of the days and of the seasons.

With cellular heat exchange elements capable of withstanding, without deformation, relatively high temperatures (for example 150° C. in the case of metal elements insensitive to seawater at the walls provided with narrow troughs) and with suitable forced feed means for the liquid to be distilled, it is possible to make the array of heat exchange elements of a distillation plant employing the second and third processes of the invention work in overpressure mode. This would allow the performance coefficient of such a plant to be appreciably increased, depending directly on the temperature of the hot water delivered by the conventional boiler used. This variant could be suitable for solving particular problems specific to certain concentrate industries, especially when the evaporation elements in question will not be hollow but only flat, as will be explained below.

The applications of the distillation plants according to the invention will be completely different depending on the type of boiler employed. In the case of solar boilers, especially accumulation-type solar boilers, the relevant markets will be firstly that of the economic, domestic or community production of fresh water for supply and/or irrigation in dry coastal regions, in deserts with a subsoil rich in brackish water and in tropical regions having only polluted water. Added to these markets may be that of the production of brine in salt marshes. In the case of conventional boilers (domestic water heaters or central heating boilers), the relevant markets for distillation plants according to the three processes of the invention will be, on the one hand, that of the economic production of fresh water on pleasure ships and, on the other hand, that of economic production of concentrates in various industries, and especially in sugar factories. For some applications, the noncondensable gas, which must be present in the distillation plants, could be not air but an inert gas (nitrogen, for example). In all cases, the construction and the operation of the treatment chambers would be very similar. As regards concentrates, the distillation plants according to the invention make it possible to beneficially almost triple the concentration of salt or of sugar in the water to be treated.

A comparison will now be made between the respective advantages and disadvantages of the distillation plants according to the invention shown in FIGS. 8, 9 and 10.

In the case of the plant shown in FIG. 8, the turbine used consumes a relatively large amount of power, very much greater than that needed to operate a fan for producing a stream of low-pressure air. However, this consumption is marginal compared with the energy produced by the alternator associated with the marine engine in question. This makes it possible to construct, so as to operate economically, domestic or community, electricity/fresh water cogeneration plants of small capacity (20 m³/day) or moderate capacity (several hundreds of m³/day) for the distillation of seawater. These plants have a performance coefficient at least equal to that of the large and expensive industrial seawater desalination units of the MSF or reverse osmosis type.

In the case of the plant shown in FIG. 9, two treatment chambers are used instead of one, as in the first plant according to FIG. 8. This has the effect, for a given total number of heat exchange elements and a given total volume of these chambers, of halving the surface areas for heat exchange assigned to condensation and to evaporation respectively. The performance levels that can be obtained by this second plant, using the free energy provided by a solar boiler, are estimated to be one cubic meter of fresh water per kWh electric consumed by the turbine. In short, this demonstrates a certain benefit of this second process over the first. This conclusion remains correct with boilers of a conventional type.

In the case of the plant shown in FIG. 10, a single treatment chamber is again used. However, in this single treatment chamber the surface areas for heat exchange assigned to vapor condensation and liquid evaporation respectively are again, for a given volume of this chamber, half those in the case of the first plant. This drawback is largely compensated for by the fact that no electrical power is now needed. Under these conditions, the construction, operation and maintenance of seawater distillation plants according to the third process of the invention, intended for hot regions, whether industrialized or not, using nonpotable water, are particularly standard and inexpensive. In fact, they require no electrical power and rely on a standard solar boiler (having a thermal power of between 0.3 and 3 kW), with or without accumulation, combined with a thermally insulated treatment chamber containing a few tens or at most one or two hundreds of square meters of inexpensive heat exchange elements according to the invention. Furthermore, the use of a solar boiler with accumulation allows a distillation plant according to the invention to be operated day and night.

To conclude these comparisons, it should be noted that with distillation plants comprising a given number of square meters of heat exchange elements, corresponding to a given thermal power of the boiler, those equipped with a solar boiler, with or without accumulation, have respective stable production times of a few hours or of one or two days. In the case of distillation plants equipped with a solar boiler without accumulation, it is necessary to prevent, from twilight, the hot water contained in the heat exchange elements from being discharged by the inflow of cold seawater to be distilled. To do this, the tap 257 for controlling the flow rate of this water may include an automatic operating device sensitive to solar radiation. Such a tap is unnecessary in the case of an accumulation-type solar boiler.

The invention is, of course, not limited to the embodiments of the improved distillation plants and heat exchange elements described above.

The distillation plant according to the first process of the invention, described in FIG. 8, treats moderate flows of hot water. By increasing the number of square meters for heat exchange and, at the same time, the dimensions of the treatment chamber, depending on the available space, this same type of plant is very suitable for treating much larger flows of hot seawater (especially those produced by the cooling of onboard marine engines), up to 200 m³/day for example, so as to produce, per treatment chamber, at least 100 m³ of fresh water per day.

The plants described in FIGS. 8 and 9 may operate with a solar boiler, with or without accumulation, operating with a pump or by the thermosiphon effect. In the case of the plant according to FIG. 8, the outlet of the solar boiler will terminate in the valve 99 placed at the inlet of the reservoir 101, and the inlet of this boiler will be connected, on one side, to an outlet line of this reservoir, similar to the conduit 12, and, on the other side, to a conduit provided with a valve for feeding the plant with seawater to be distilled, which is preferably preheated. Moreover, the plant according to FIG. 9 may include, depending on the particular operating conditions, several groups of double (evaporation and condensation) treatment chambers, each chamber comprising only a small number of heat exchange elements, all connected to one another according to their respective functions.

Likewise, the plant described in FIG. 10 may operate with a conventional boiler, with or without a circulating pump. As regards the solar still according to FIG. 10, it should be noted that several solar heating tanks may be installed in parallel beneath the same thermal protection covering, so as to form a large total surface area for absorbing the solar radiation, for example 10 m². In hot regions, this would give such a water heater a daily thermal energy of 60 kWh, capable of producing at least 2 m³ of fresh water per day, by means of a compact treatment chamber containing heat exchange elements having a total surface area of a hundred square meters or so.

According to the invention, the heat transfer liquid for the distillation plants described in FIGS. 9 and 10 may be not the liquid to be distilled, but for example pure water. For this purpose, the conduit 194 and the valve 196 of FIG. 9, which feed the plant with liquid to be distilled, will be connected, no longer to the conduits 192 and 193 running into the bottom couplers of the heat exchange elements of the condensation chamber 152, but to a suitable heat exchanger immersed in the reservoir 168 of the boiler. This exchanger will supply the pipes 164a . . . f that bring hot liquid to the external walls of the heat exchange elements of the evaporation chamber. A similar arrangement could be applied to the plant according to FIG. 10, especially when the boiler is of a conventional type.

In the distillation plants according to FIGS. 9 and 10, in which the heat transfer liquid is the liquid to be distilled, it is beneficial to preheat the cold liquid to be distilled before it is introduced into coldest point of the looped circuit followed by the liquid circulating in the heat exchange elements of these plants. Such heating-up will be carried out by means of a suitable heat exchanger through which, on the one hand, the distillate and/or the condensate produced and, on the other hand, the cold liquid to be distilled flow. The temperature rise thus given to the cold liquid to be distilled results in an overall temperature rise over the entire length of the looped circuit followed by the circulating liquid. More specifically, this heating-up of cold liquid to be distilled results in a similar increase in the temperature of the hot liquid produced by the boiler and in an equivalent reduction in the temperature drop suffered by the liquid leaving the evaporation elements before it is introduced into the base of the condensation elements. These two variations, in opposite directions, of the temperatures of the liquid entering the heat exchange elements in question have the consequence of directly increasing the performance coefficient of the plants.

FIGS. 9 and 10 show distillation plants according to the invention in which the heat exchange elements used are hollow and vertical. In two first variants that can be applied to the respective distillation plants thus shown, the evaporation heat exchange elements will remain hollow and flat, but will no longer be vertical and, on the contrary, will lie in slightly inclined parallel planes. In both cases, the upper wall of the evaporation elements will be equipped with one of the means defined above for ensuring that the liquid to be distilled is spread out uniformly. These means may be chosen to be a web of hydrophilic felt, a sheet of porous sintered powder or wide shallow troughs arranged in cascade. As regards the condensation heat exchange elements, these will be inclined like the evaporation elements and will be rectangular, hollow and flat panels provided with hydrophilic or wettable coatings, ensuring suitable retention of the condensed liquid by virtue of the fact that the capillary forces involved are greater than the gravity forces in question.

In the case of a plant according to the second distillation process, the evaporation and condensation elements will be installed in several parallel layers in two separate chambers. A pump for circulating the liquid and a fan for circulating the gas will be required. Under these conditions, the condensation elements may possess hydrophilic or wettable coatings on both their faces, their total surface area remaining approximately equal to that of the evaporation elements.

In the case of a plant according to the third distillation process, several layers of pairs of evaporation and condensation elements of the same size, placed opposite one another, will be installed in the same treatment chamber, these being slightly inclined and separated from one another by a sheet of insulating material. A pump for circulating the liquid will be required.

In two other variants that can be applied to the distillation plants according to FIGS. 9 and 10 respectively, the hollow and flat evaporation heat exchange elements used will be replaced with simple rigid plates. A wall of these plates will be provided with means for ensuring that the flow of any liquid spilled over said wall is spread out effectively, and these plates may be vertical or slightly inclined. In the distillation plants modified in this way, the heat transfer liquid is the liquid to be distilled and this spills hot at the top of the evaporation plates. In both cases, a pump will be needed to make the liquid circulate in a closed circuit and, in the case of a construction with separate evaporation and condensation chambers, a fan for making the noncondensable gas circulate will also be required. These plants thus modified will be respectively constructed according to the same general architectures (1) whether those illustrated in the FIGS. 9 and 10, using vertical elements and (2) whether those specified above in the case of the first two variants, using hollow and flat, slightly inclined elements. This type of plant, equipped with such evaporation plates, produces a particularly dense concentrate (brine or syrup) since all of the hot liquid to be distilled is spilled over the upper wall of the evaporation plates and only a small portion of this circulating liquid is evaporated at each pass. Such a feature has a particular benefit in the case of salt marshes and sugar factories.

It should be noted, on the one hand, that the latter two variants of the distillation plants according to the invention are in accordance with the second and third particular characteristics respectively of the general distillation process defined above and, on the other hand, that the two-chamber variant is fundamentally different from the Desplats technique described in the presentation of the known distillation processes.

The upstream and downstream connection members for the heat exchange elements described above are tubes placed in the plane of these elements, but each connection tube may be replaced with two rings, of considerably greater diameter, installed respectively on the two sides of a lateral, hollow and flat excrescence added to the rigid reinforcements of the element. This makes it possible to reduce the head losses of the fluids, and especially of the gases, circulating in the heat exchange elements.

As regards the form of the heat exchange elements according to the invention, it should be pointed out that although elements with plane walls allow a treatment chamber having a rectangular cross section to be optimally filled, it will be preferred to use elements having a curved cross section, in contiguous sections, if, for any reason, the chamber were to be circular or elliptical.

Moreover, it should be noted that the respectively flexible and rigid plastics (polyethylene and polypropylene) mentioned above by way of example for manufacturing two particular types of cellular heat exchange elements according to the invention do not in any way exclude the use of other polymer materials provided that these meet the selection criteria involved. In fact, any plastic which is inert with respect to liquid foods may in principle be suitable. More specifically, such plastics capable of forming flexible sheets (if necessary thermally curable ones) such as PVC or polyurethane, may therefore be used for producing elements based on flexible sheets according to FIG. 1. Likewise, plastics that can be used for forming hard articles, such as rigid panels, especially polycarbonate or ABS, may also be used for producing heat exchange elements according to FIGS. 5 and 7.

In dry coastal regions, electrical power stations that use seawater for their cooling will be able, by virtue of the distillation processes according to the invention, to utilize their hot seawater discharges to produce fresh water particularly economically. The same applies to marine engines with which large and medium tonnage ships are equipped, especially to engines of cruise ships. In all cases, it will be advantageous to prefer the first distillation process according to the invention which, for the same quantity of fresh water produced, requires square meters of heat exchangers that are fewer by a factor of two and less bulky, but a relatively large amount of electrical or mechanical power to make the necessary turbine rotate.

To convert polluted water into drinking water in subtropical regions, it is advantageous, after decanting and filtering this water, to use a distillation plant according to the invention, especially that produced according to the third process which employs a solar boiler with accumulation and requires no electrical power. If, after distillation, the fresh water produced were still to contain a dangerous proportion of bacteria, it will be possible for a bactericidal gas (for example chlorine) to be continuously or periodically introduced in to the treatment chamber. This additional gas, by being mixed with the noncondensable gas of the treatment chamber, will allow the fresh water produced to be easily sterilized.

1. A multiple-effect distillation process intended to separate materials in solution from their liquid solvent, characterized in that it uses a countercurrent heat exchange, one of the streams ensuring that the liquid evaporates and the other that vapor condenses, in such a way that the heat of condensation of the vapor is recovered in order to evaporate and/or reheat the liquid at a lower partial vapor pressure, this partial pressure being able to be varied and obtained by virtue of the presence of a noncondensable gas that ensures an approximately uniform total pressure.

2. The distillation process as claimed in claim 1, characterized in that the noncondensable gas is used as heat-transfer fluid, however the evaporation and condensation operations are carried out on either side of the walls, at a nonuniform temperature, of a heat exchanger, through which walls the heat flux passes, in that the flows of the gas transporting the vapor are produced countercurrently during these operations, in that the liquid to be evaporated advances along one of the faces of the walls of the heat exchanger and in that the distilled liquid condenses on the other face, the hot and cold sources being located at the two ends of the stream of gas looped back on itself thus formed.

3. The distillation process as claimed in claim 1, characterized in that the evaporation of the liquid to be distilled is carried out on one or more hot surfaces, operating at a nonuniform temperature, these being installed in a first treatment chamber, and the condensation of vapor carried out on one or more other surfaces, operating at a nonuniform temperature generally colder than the previous one, these other surfaces being installed in a second treatment chamber communicating with the first via the top and via the bottom, the various regions of the evaporation and condensation surfaces being maintained locally at the required temperatures by virtue of the countercurrent circulation of a heat transfer fluid along these surfaces, a hot source being placed between the hottest ends of the evaporation and condensation surfaces and a cold source, installed between their coldest ends, the heat exchanges between the hot surface and the colder surface being ensured by the closed-circuit circulation, in a direction opposite to that of the heat transfer fluid, of a noncondensable gas passing from one chamber to the other, which chambers are at a uniform total pressure.

4. The distillation process as claimed in claim 1, characterized in that the evaporation of the liquid is carried out on one or more hot surfaces operating at a nonuniform temperature and the condensation of vapor carried out on one or more other surfaces placed opposite the previous ones, operating at an overall colder nonuniform temperature, the various regions of the evaporation and condensation surfaces being locally maintained at the required temperatures by virtue of the countercurrent circulation of a heat transfer fluid, a hot source being placed between the hottest ends of the evaporation and condensation surfaces and a cold source, installed between their coldest ends, the differences in partial saturation vapor pressure between the various regions of said surfaces being ensured by the presence of a noncondensable gas in a treatment chamber at a uniform total pressure.

5. The distillation process as claimed in claim 2, characterized in that, in this process:
hollow and flat, quasireversible liquid/vapor heat exchange elements (60 or 104a . . . g) are placed, so as to be vertical or inclined, in a thermally insulated treatment chamber (102), with narrow separating spaces (106a . . . h), of approximately constant width (14a-b), that are filled with a noncondensable gas;
the liquid to be distilled is heated and vapor (118) is produced in a reservoir (101);
a stream (120-122) of hot gas saturated with vapor (118) flows downward inside the elements (104a . . . g), while hot liquid (114) slowly flows (112) along their outer walls;
at the outlet of these elements, a gas/liquid separation (128) is carried out and the gas is slightly cooled (130) before being introduced (137) into the base of the spaces (138a . . . h) that separate the elements (104a . . . g), so as to flow upward along their outer walls;
the gas leaving these separating spaces bubbles (143) into hot liquid (114) and the circuit traveled through by this gas is thus a closed circuit;
the distillate is collected (146) after gas/liquid separation; and
the concentrate is collected at the bottom (148) of the spaces that separate the elements.

6. The distillation process as claimed in claim 3, characterized in that, in this process:
hollow and flat, quasireversible liquid/vapor heat exchange elements (158a,b,c and 160a,b,c) are placed, so as to be vertical or inclined, in two thermally insulated (153-155) treatment chambers (152-154) that communicate via the top (174) and via the bottom (176), the said chambers being assigned to liquid evaporation and to vapor condensation respectively, in such a way that these elements are separated in pairs therein by a narrow open space (132a . . . d), of approximately constant width, which is filled with a noncondensable gas;
a heat transfer liquid is heated in a boiler (168) and made to circulate in a closed circuit downward inside the elements (160a,b,c) of the evaporation chamber (152), then, after being cooled slightly (191), upward inside the elements (158a,b,c) of the condensation chamber (154) and finally brought back to the boiler (168);
hot liquid to be distilled spills (162a,b,c and 164a,b,c) at the top of the outer walls of the elements of the evaporation chamber and slowly flows along these walls;
a stream of gas saturated with vapor circulates (174-176) in a closed circuit between the heat exchange elements, flowing downward from the top of the condensation chamber (152) and then upward from the bottom of the evaporation chamber (154);
a defined flow (194-196) of cold liquid to be distilled continuously replaces the flow of hot liquid spilled over the heat exchange elements of the evaporation chamber;
the distillate is collected at a bottom point (198) of the condensation chamber (152); and
the concentrate is collected at a bottom point (200) of the evaporation chamber (154).

7. The distillation process as claimed in claim 4, characterized in that, in this process:
hollow and flat, quasireversible liquid/vapor heat exchange elements (224a,b,c-226a,b,c), are installed, so as to be inclined or vertical, in a thermally insulated treatment chamber (223) in such a way that these elements are separated in pairs by a narrow space, of approximately constant width, which is filled with a noncondensable gas;
the elements are distributed in two groups, assigned to liquid evaporation (224a,b,c) and to vapor condensation (226a,b,c) respectively, each condensation element being placed between two evaporation elements;
a heat transfer liquid is heated in a boiler (222) and made to circulate in a closed circuit downward inside the evaporation elements (224a,b,c), then, after being cooled slightly (242), upward inside the condensation elements (226a-b) and finally brought back the boiler;
hot liquid to be distilled spills (230a,b,c) at the top of the outer walls of the evaporation elements (224a,b,c) and slowly flows along these walls;
cold liquid to be distilled continuously replaces (254-257) the hot liquid spilled at the top of the outer walls of the evaporation elements;
the distillate is collected at the bottom (257a-b, 259a-b) of the walls of the condensation elements; and
the concentrate is collected at the bottom (256a,b,c) of the walls of the evaporation elements.

8. The distillation process as claimed in either of claims 6 and 7, characterized in that the heat transfer liquid circulating in a closed circuit is the liquid to be distilled and the cold liquid to be distilled is added to the first liquid, at the point in the circuit where it is coolest.

9. The distillation process as claimed in one of claims 5, 6 and 7, characterized in that the cold liquid to be distilled is preheated by a heat exchange with the concentrate and/or the distillate.

10. The distillation process as claimed in either of claims 6 and 7, characterized in that, since the heat transfer liquid is the liquid to be distilled, this being added cold or preheated at the coolest point of the circuit, the hollow and flat evaporation heat exchange elements used are replaced with rigid plates, that are vertical or slightly inclined, one of the walls of which is provided with means for spreading out, as a substantially uniform thin layer, the liquid spilled over this wall.

11. The distillation process as claimed in claim 5, 6 or 7, characterized in that the boiler (222-128) is installed beneath the treatment chamber(s) (223 or 152-154), and the distance between the boiler and the reservoir (101) and/or the treatment chamber(s) is sufficient to allow the liquid to be distilled to circulate by a thermosiphon effect.

12. The distillation process as claimed in one of claims 5 to 11, applied to the production of fresh water, characterized in that the boiler (122) is a solar water heater, with or without accumulation, combined with a reservoir, said water heater is, if necessary, oversized with respect to the treatment capacity of the heat exchange elements of the treatment chamber and said reservoir then possesses a volume very much greater than the total volume of the heat exchange elements used.

13. A heat exchange element (10, 60, 94a-b), characterized in that it is hollow and flat, with at least one of its outer walls provided with means for effectively spreading out the flow, by gravity and/or capillary effect, of a liquid spilled over this wall, which wall may be substantially flat or cylindrical.

14. The heat exchange element as claimed in claim 13, characterized in that said means for spreading out the flow consist either of a hydrophilic or wettable, permeable fabric or agglomerate (15), or of narrow (97) or wide (99), shallow, parallel troughs intended to be placed horizontally.

15. The heat exchange element as claimed in claim 14, characterized in that this element is mechanically stable in the presence of relatively hot liquids at below 100° C. and it constitutes a set of long juxtaposed conduits (18, 62) having outer walls that conduct heat well, said set being provided (1) with upstream couplers (26, 72) and downstream couplers (30, 73) that emerge in connection members (2832, 74-75); (2) with fitting means (46, 77) suitable for allowing said conduits to be placed vertically or at any suitable angle of inclination; and (3) with rigid lateral reinforcements (14a-b, 68-69), especially those suitable for determining the spacing of the assembly of juxtaposed elements and/or the width and the thickness of the element.

16. Heat exchange element as claimed in claim 15, characterized in that it forms a rectangular flexible sheet (10), grouping together numerous narrow conduits (18) that are formed between parallel longitudinal weld seams (16), these being produced between two polymer membranes, having on the outside and, if required, also on the inside, a hydrophilic coating (15) that is welded or adhesively bonded, and said couplers (26, 32) are formed by two transverse weld seams.

17. The heat exchange element as claimed in claim 15, characterized in that it is a flat or curved, rigid cellular panel (60) provided with a hydrophilic or wettable coating, which is welded or adhesively bonded, and each of its upstream and downstream couplers (72-73) forms a kind of elongate flat cover, having thin walls, said cover being fitted over the ends of this panel and sealably fixed thereto.

18. The heat exchange element as claimed in claim 15, characterized in that it is a rigid, rectangular, hollow panel (96a-b) having at least one of its outer walls (95-98) provided with narrow (97) or wide (99), shallow parallel troughs arranged transversely in cascade and, if required, with a hydrophilic or wettable internal coating, the panels provided with narrow troughs being intended to be installed vertically and the panels provided with wide troughs being intended to be installed along planes slightly inclined to the vertical.

19. The heat exchange element as claimed in claim 15, characterized in that the spreading means with which at least one of its walls is provided are, by choice, (1) a permeable agglomerate consisting of a nonwoven or a hydrophilic felt of cellulose or else a wettable sheet of porous sintered powder; (2) a permeable woven fabric made of hydrophilic cotton or of wettable impermeable yarns; and (3) narrow troughs, made of metal or extruded hard plastic or else of thermoformed plastic.

20. A distillation plant having a high performance coefficient, characterized in that it comprises:
a thermally insulated treatment chamber (102);
a large number of hollow and flat heat exchange elements (60 or 104a . . . g), having at least one of their outer walls provided with means for spreading substantially uniformly a flowing liquid over said at least one of their outer walls and, if required, inner walls provided with similar spreading means;
these elements being installed in this chamber in such a way that they are separated in pairs by a narrow open space (106a . . . h), of approximately constant width, filled with a noncondensable gas, especially air, and in that their walls are vertical or slightly inclined to the horizontal;
upstream and downstream headers (124-126) connected to the respective top and bottom couplers of these elements;
a boiler for heating the liquid to be distilled and for producing vapor (118) in a reservoir (101);
a turbine (120) and suitable conduits (122-124) for making a stream of hot gas saturated with vapor (118) flow downward in said elements (104a . . . g);
suitable troughs and accessories (110a . . . g, 50-52), these all being designed to make the hot liquid (114) produced by the boiler flow uniformly downward to the bottom of the outer walls (104′a . . . g) of said elements (104a . . . g);
an air/liquid settling bottle (128), installed at the outlet of the downstream header (126) for the elements;
a heat exchanger (130), having its inlet connected to the top outlet of the settling bottle (128), installed in a cooling vessel (132) fed with liquid at the outside temperature and placed above this bottle;
a conduit (136) for connecting the outlet of this exchanger (130) to pipes (138a . . . h) running into the base of the open spaces (106a . . . h) that separate said elements (104a . . . g);
a header (142) which is connected to conduits (100a . . . h) running into the top of the open spaces (106a . . . h) and is provided with an end-piece (143) that is immersed in the hot liquid (114) contained in the reservoir (101) fed by the boiler (99);
a pipe (146) for collecting the distillate at the bottom outlet of the settling bottle (118); and
a pipe (148) for collecting the concentrate at the bottom of the open spaces (106a . . . h) that separate the elements.

21. A distillation plant having a high performance coefficient, characterized in that it comprises:
two treatment chambers (152-154) having thermally insulated outer walls (153-155), assigned to liquid evaporation and vapor condensation respectively, which are separated by an insulating central partition (156);
two large groups of hollow and flat heat exchange elements (158a,b,c and 160a,b,c), having at least one of their outer walls provided with means for substantially uniformly spreading a liquid flowing over it;
these two groups being respectively installed in these two chambers in such a way that their elements are separated in pairs by a narrow open space, of approximately constant width, filled with a noncondensable gas, especially air, (170a . . . d and 172a . . . d) and in such a way that their outer walls are vertical or slightly inclined to the horizontal;
top and bottom headers (178-182 and 184-193) associated with the elements of the two chambers (152-154);
a boiler (168) for heating a heat transfer liquid;
a conduit (180) for connecting the inlet of the boiler (168) to the top header (178) of the elements (158a,b,c) of the condensation chamber (152) and a conduit (166) for connecting its outlet to the top header (182) of the elements (160a,b,c) of the evaporation chamber (154);
a member (191) that produces slight cooling, placed between the bottom headers (184-193) of the elements of the two chambers (152-154);
means (188) for making the heat transfer liquid circulate in a closed circuit in the evaporation elements (160a,b,c), in the cooling member (191), in the condensation elements (158a,b,c) and finally in the boiler (168), the liquid flowing downward in the evaporation elements and upward in the condensation elements;
means (174-176) for making the hot wet gas flow from the evaporation chamber (154) to the top of the condensation chamber (152) and for making the cooled dried gas flow from the condensation chamber to the bottom of the evaporation chamber;
suitable troughs and accessories (162a,b,c and 164a,b,c), these all being suitable for producing a uniform flow, from the top to the bottom of at least one of the outer walls of the elements of the evaporation chamber (154), of the liquid to be distilled, directly or indirectly, heated by the boiler (168);
a conduit (194), fed with liquid to be distilled, and a valve (196), these together being suitable for providing the plant with a defined flow rate (194-196) of liquid to be distilled; and
a pipe (198), connected at a bottom point of the condensation chamber (152), for collecting the distillate and a pipe (200), connected at a bottom point of the evaporation chamber (154), for collecting the concentrate.

22. The distillation plant as claimed in claim 21, characterized in that the means for making the noncondensable gas circulate in the condensation chamber (152) and the evaporation chamber (154) comprise two openings, made at the top and at the bottom of the central partition (156) respectively, one opening (174) being wide and the other being either smaller but equipped with a fan (176) or identical to the first.

23. A distillation plant, having a high performance coefficient, characterized in that it comprises:
a thermally insulated treatment chamber (223);
a large number of hollow and flat heat exchange elements (224a,b,c-226a,b,c), having at least one of its outer walls provided with means for spreading out approximately uniformly a liquid flowing over it;
these elements being installed in this chamber in such a way that they are separated in pairs by a narrow open space, of approximately constant width, filled with a noncondensable gas, especially air, and in such a way that their outer walls are vertical or slightly inclined to the horizontal;
said elements being distributed in two groups, assigned to the liquid evaporation (224a,b,c) and to the vapor condensation (226a,b,c), respectively, each condensation element being placed between two evaporation elements;
top headers (234-250) and bottom headers (244-240) equipping the elements of each of the two groups;
a boiler (222) fed with a heat transfer liquid;
two thermally insulated lines (252-235) connecting the inlet and the outlet of the boiler (222) to the top headers (250-234) of the condensation elements (226a-b) and evaporation elements (224a,b,c), respectively;
a member (242) that produces slight cooling, placed between the bottom headers (240-244) of the elements of the two groups;
means for making the heat transfer liquid flow in a closed circuit in the evaporation elements (224a,b,c), in the cooling member (242), in the condensation elements (226a-b) and finally in the boiler (222), the liquid flowing downward in the evaporation elements and upward in the condensation elements;
suitable troughs and accessories (230a,b,c, 50-52, 86-88), these together being suitable for producing a uniform flow, from the top to the bottom of at least one of the outer walls of the evaporation elements (224a,b,c), of the liquid to be distilled, directly or indirectly, heated by the boiler (222);
conduits (254-255) and a valve (257), these being suitable for delivering into the plant a defined flow of the liquid to be distilled;
means (54-56, 90-92, 257a-b, 259a-b) for collecting the distillate which flows out from the outer walls of the condensation elements (226a-b); and
means (54-56, 90-92, 256a,b,c, 258) for collecting the concentrate which flows out from the outer walls of the evaporation elements (224a,b,c).

24. The plant as claimed in claim 21 or 23, characterized in that the means for making the liquid circulate in a closed circuit in the elements comprise a pump (188).

25. The distillation plant as claimed in claim 20, 21 or 23, characterized in that the boiler (222-128) is installed beneath the reservoir (101) and/or the treatment chamber(s) (223 or 152-154), and the distance between the boiler and this reservoir and/or the treatment chamber(s) is sufficient to allow the liquid to be distilled to circulate by a thermosiphon effect.

26. The distillation plant as claimed in one of claims 20 to 25, applied to the production of fresh water, characterized in that the boiler (122) is a solar water heater, with or without accumulation, said heater being provided with a surface (266) that absorbs solar radiation and with an associated reservoir, said surface being, if necessary, oversized with respect to the treatment capacity of the heat exchange elements of the treatment chamber and said reservoir then possessing a volume very much greater than the total internal volume of these elements and, where appropriate, the associated reservoir (101).

27. The distillation plant as claimed in claims 21 and 23, characterized in that the heat transfer liquid is the liquid to be distilled and in that the latter is introduced between the bottom headers (240-244) of the evaporation heat exchange elements (160a,b,c or 224a,b,c) and the condensation heat exchange elements (158a,b,c or 226a,b,c).

28. The distillation plant as claimed in one of claims 20, 21, 23, characterized in that the cold liquid to be distilled is preheated in a suitable heat exchanger fed by the distillate and/or the condensate.

29. The distillation plant as claimed in either of claims 21 and 23, characterized in that, since the heat transfer liquid is the liquid to be distilled, where appropriate preheated before it is introduced into the condensation elements, in this plant, the previously provided hollow and flat evaporation elements are replaced with a rigid evaporation plate placed vertically or slightly inclined to the horizontal, this plate having at least one wall provided with means for spreading out, approximately uniformly, a liquid flowing over it.

30. The distillation plant as claimed in one of claims 20 to 29, characterized in that the treatment chamber(s) have a rectangular bottom and the heat exchange elements in question have approximately plane outer walls of rectangular shape, said heat exchange elements being installed so as to be vertical or slightly inclined to the horizontal.
